(19) United States
(12) Patent Application Publication
(10) Pub. No.: US 2016/0173923 A1
(43) Pub. Date: Jun. 16, 2016

(54) System and Method for Implementing Media Display Systems

(71) Applicant: Charles Arthur Bastyr, Del Mar, CA (US)

(72) Inventor: Charles Arthur Bastyr, Del Mar, CA (US)

(21) Appl. No.: 14/566,509

(22) Filed: Dec. 10, 2014

(51) Int. Cl. H04N 21/262; H04N 21/643; H04N 21/61; H04N 21/437; H04N 21/433

(52) U.S. Cl. CPC H04N 21/262; H04N 21/437; H04N 21/433; H04N 21/6131; H04N 21/6181; H04N 21/64322

(57) ABSTRACT

The invention comprises a system and a method for implementing media display systems. The system provides for the uploading and storing of media on a server, display units establishing communication with the server, selecting which media will be displayed on which display unit, establishing a schedule governing when the media will be displayed, and the display unit downloading the media from the server and displaying it as governed by the schedule.

### FIELD OF THE INVENTION

The invention pertains to generally to media display systems. More specifically, the invention pertains to a system and method for implementing media display systems.

### BACKGROUND OF THE INVENTION

Signs are widely used for a variety of purposes in retail stores and malls, restaurants and bars, hotels, corporate buildings, transportation terminals, along roads and highways, and in other public locations. Signs are used to advertise, generate sales, build brands, influence people's behavior, communicate information, educate, enhance the viewer's experience, and for many other uses.

Signs typically take one of two forms: static or electronic. Static signs are printed. After printing, each sign must be delivered to the location where it will be displayed, and then be manually installed. To change the sign, the same process of printing, delivery and installation must take place, as well as removal and disposal of the previous sign. This process is costly, time-consuming, labor intensive, and lacks flexibility. Furthermore, static signs do not allow multiple messages to be displayed sequentially in a location without the human intervention of manually changing the signs.

Electronic signs fall into two categories: open and closed systems. In a closed system electronic signs are controlled by a personal computer or a media server at the same location as the electronic sign. Changes to the content on the signs must be made onsite with the personal computer or through updates to the media server. Electronic signs in an open system can be updated with varying degrees of difficulty and limitations by logging in to the local computer or media server that is controlling the electronic sign.

It is common practice for businesses to employ routers/firewalls as their interface to the Internet to prevent Internet-based fraudulent and malicious exploits. Accordingly, to be able to initiate communication with a device such as an electronic sign or the local computer or media server controlling the electronic sign, from the Internet side of the router/firewall, it is necessary to open ports in the router/firewall (a practice commonly known as port forwarding) for communication to take place. This practice suffers from several practical hurdles. First, to open the ports in the router requires having the login credentials for the router/firewall. Typically, most businesses do not have this information readily available, delaying or preventing this task from being completed. Second, it is common that businesses have other vendor services that communicate via the same router/firewall interface. Such vendor services include point-of-sale systems, music and video services, reservations systems, and others. In those cases where the login credentials are available and the required communication settings are made in the router/firewall, it is common that a subsequent vendor makes changes in the router/firewall settings whereby the settings that were made to communicate with the electronic sign, or the local computer or media server controlling the electronic sign, are disabled. And finally, using port forwarding in a router makes it possible for external port scanners to detect the port forwarding and exploit security vulnerabilities in the security protection, if any, of the electronic sign, or the local computer or media server controlling the electronic sign.

In light of the above, it is the object of the present invention to provide a media display system that transmits and displays media, which can be changed remotely via Internet, cellular, or other electronic communication methods, that does not require an individual to perform any physical tasks at the location of each display unit, and that does not require IT expertise to install, operate or maintain. Another object of the invention is to provide the capability to simultaneously change the media on a single display unit at a single location or any number of display units at any number of locations. Another object of the invention is to provide the capability to display different media on different display units. Another object of the invention is to provide the capability to automatically display a sequence of media governed by a user defined schedule. Yet another object of the invention is to provide a media system for implementing the display of media that is flexible, quick, comprehensive, efficient and low-cost.

Other objects, features and advantages of the invention will become apparent from the following description, taken in conjunction with the accompanying drawings, which illustrate, by way of examples, the principle of the invention.

### SUMMARY OF THE INVENTION

One aspect of the present invention is to provide a system for implementing a media display system that is flexible, quick, comprehensive, efficient and low-cost. The invention allows users to change the media remotely from anywhere worldwide on an individual display unit in one location or on any number of display units in any number of locations, allows different media to be displayed in an order and for an amount of time as governed by a user defined schedule, and provides a centralized server for management, control and distribution of media from anywhere worldwide.

Accordingly, one aspect of the invention includes a method for users to securely log into a server remotely from anywhere worldwide via Internet, cellular or other form of electronic connectivity.

According to another aspect, the invention includes a method of selecting and uploading media files from anywhere worldwide to a server and storing said files on the server. The method also comprises selecting one such media file from a list of media files on the server and displaying the media within that media file on a display unit located anywhere worldwide.

According to another aspect, the invention includes a control module for initiating communication with a server. The control module comprises a processor programmed to find a network connection, to establish communication with a server and send unique identification reference information to the server. The control module also comprises a memory configured to store one or more media files downloaded from the server by the control module. The processor is further programmed to display the media within the media files on a display.

According to another aspect, the invention includes the method of displaying media on one display unit in one location, multiple display units in one location, or any number of display units located in any number of locations worldwide.

According to yet another aspect, the invention includes the method of concurrently displaying different media on different display units located in one or more location.

According to another aspect, the invention includes a control module for initiating communication with at least one display. The control module comprises circuitry adopted to communicate with at least one display. The control module also includes a memory configured to store media files. The control module also includes a processor programmed to identify any such at least one display that it has established communication with, and to output the media within the media files stored in the memory to said at least one display.

According to another aspect, the invention includes a method for selecting two or more different media files and displaying the media within the media files in an order and for an amount of time as governed by a user defined schedule. The method comprises selecting two or more media files from a list of media files on a server and displaying the media within each media file on one or more display units located in one or more locations in an order and for an amount of time as governed by the schedule. The method also comprises specifying the time, if any, when no media will be displayed. The method further comprises the ability to repeat a schedule any number of times.

According to another aspect, the invention includes a control module for downloading at least one media file and displaying the media within the media file on a display. The control module comprises circuitry adopted to download a schedule from a server. The control module also includes a memory configured to store the schedule, wherein the schedule includes one or more media files and a time grid. The control module also includes a processor programmed to output the media within the media files to a display in an order, and for an amount of time as governed by the time grid.

According to another aspect, the invention includes the method of creating more than one schedule. The method comprises creating two or more schedules and then selecting which schedule will be utilized to govern the display of media on one or more display units located in one or more locations. The method also comprises utilizing more than one schedule to simultaneously govern the display of media on different display units located in one or more locations.

According to another aspect, the invention includes a method of replicating the media file upload, management, configuration and distribution functions on the server, each for use by a unique user, wherein each user has unique login credentials that allows them secure access to only that portion of the server that has been replicated for their use. The method comprises replicating functions for each user to independently 1) upload media files from anywhere worldwide with a network connection to a server and store said media files on the server, select one such media file from a list of media files on the server and display the media within that media file on a display unit located anywhere worldwide, 2) display media on one display unit in one location, multiple display units in one location, or any number of display units located in any number of locations worldwide, 3) concurrently display different media on different display units located in one or more location, 4) selecting two or more media files from a list of media files on a server and displaying the media within each media file on one or more display units located in one or more locations in an order and for an amount of time as governed by a user defined schedule. The method also comprises specifying the time, if any, when no media will be displayed. The method further comprises the ability to repeat a schedule any number of times, and 5) utilize different schedules to simultaneously govern the display of media on different display units located in one or more locations.

### BRIEF DESCRIPTION OF THE DRAWINGS

The present invention is described in more detail below in connection with the attached drawings, which are meant to illustrate and not limit the invention, and in which:

FIG. 1A illustrates a simplified block diagram of a media display system having features according to aspects of an embodiment of the invention;

FIG. 1B illustrates a block diagram of the media display system of FIG. 1A, according to aspects of an embodiment of the invention;

FIG. 2 illustrates a block diagram of a media display system, according to aspects of an embodiment of the invention;

FIGS. 3A-3B illustrate exemplary flowcharts of the control module code, according to aspects of an embodiment of the invention;

FIG. 4 is a block diagram illustrating aspects of an alternate embodiment of the invention;

FIG. 5 is a block diagram illustrating aspects of an alternate embodiment of the invention;

FIG. 6 is a block diagram illustrating aspects of an alternate embodiment of the invention;

FIG. 7 is a block diagram illustrating aspects of an alternate embodiment of the invention;

FIG. 8 illustrates an exemplary flowchart of the server login process, according to aspects of an embodiment of the invention;

FIGS. 9A-9L schematically illustrate the content of exemplary user screens of the server code, according to aspects of an embodiment of the invention;

FIGS. 10A-10F illustrate exemplary flowcharts of the server code, according to aspects of an embodiment of the invention; and

FIG. 11 illustrates an exemplary time grid, according to aspects of an embodiment of the invention.

### DETAILED DESCRIPTION OF THE PREFERRED EMBODIMENT

The present invention includes a media display system for implementing the display of media on a display unit located anywhere worldwide with connectivity by a network to a server, which can also be located anywhere worldwide. Media is generally defined as text, audio, images, video, or the like. In addition, the media display system advantageously provides a method for changing the media being displayed in accordance with a user defined schedule. A schedule is generally defined as one or more media files and a time grid that governs when, and the length of time that the media within each media file will be displayed. Further, any number of display units located in any number of locations can display the media. Moreover, any number of display units located in any number of locations can display the media within any number of different media files, all as efficiently configured and scheduled by the user.

In order to facilitate a complete understanding of the invention, the remainder of this detailed description describes the invention with reference to the figures, wherein like elements are referenced with like reference characters throughout.

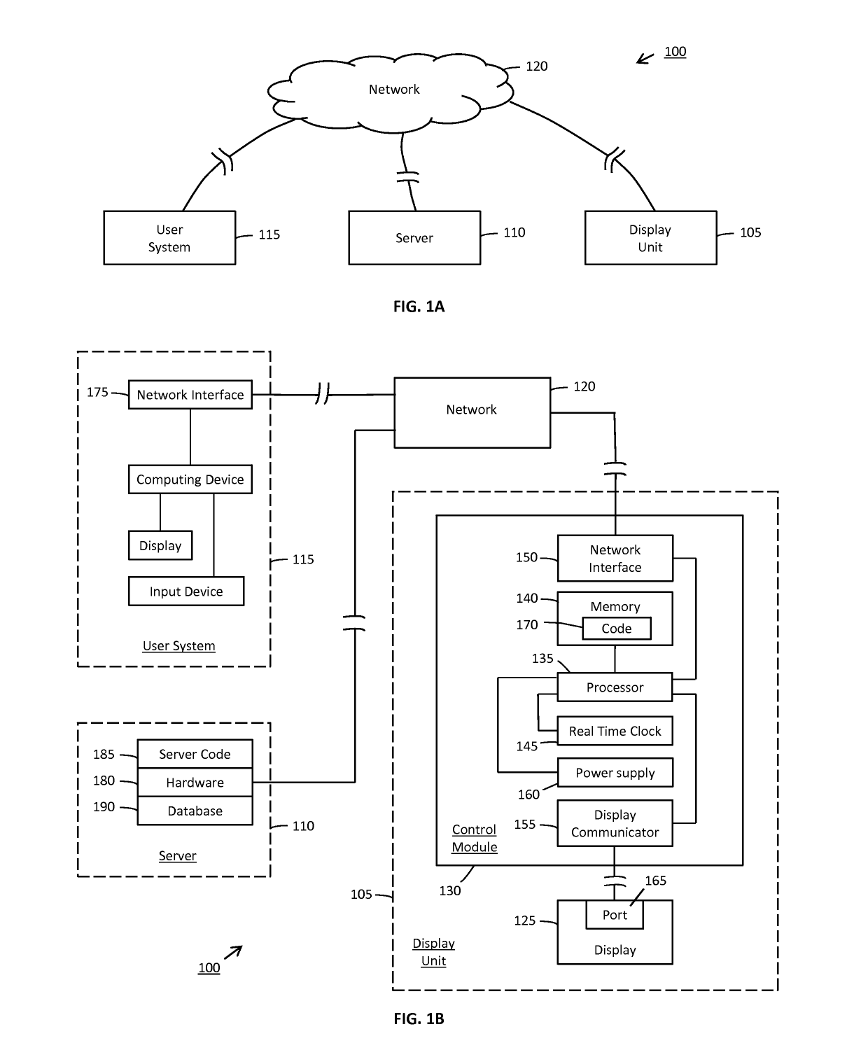

FIG. 1A illustrates a simplified block diagram of a media display system 100 having features according to an embodiment of the invention. As shown in FIG. 1A, the media display system 100 preferably includes a display unit 105, a server 110, and a user system 115. The display unit 105 preferably communicates with the server 110 via network 120 such that the display unit 105 displays media within the schedule downloaded from the server 110. From time to time, the display unit 105 preferably communicates with the server 110 via network 120 so as to download a schedule, and, if desired, download updates to the program instructions executing within the display unit 105. Preferably, network 120 comprises the Internet. However, a skilled artisan will recognize, from the disclosure herein, a wide number of alternative embodiments for the network 120. For example, the network 120 may advantageously comprise a local area network (LAN), a wide area network (WAN), an Internet area network (IAN), or the like.

FIG. 1B illustrates a block diagram of the media display system 100 of FIG. 1A having features according to an embodiment of the invention. As shown in FIG. 1B, the display unit 105 comprises a display 125 and a control module 130. Preferably, display 125 comprises a conventional color monitor. However, a skilled artisan would recognize a wide number of conventional devices, from the disclosure herein, that may connect to the control module 130 and display the media. For example, the display 125 may advantageously comprise a digital television, a LED display panel, an LCD display, an image projector such as a conventional video projector that projects the image onto a surface, or the like. The display 125 includes a port 165 for receiving data from the display communicator 155. According to the preferred embodiment, the port 165 comprises a VGA port. However, a skilled artisan would recognize a wide number of conventional devices, from the disclosure herein, that may comprise the port 165. For example, the port 165 may advantageously comprise a HDMI port, a DVI Port, a SDI port, an S-Video port, an Ethernet port, a USB port, or the like.

The control module 130 includes a processor 135 connected to a memory 140, a real time clock 145, a network interface 150, a display communicator 155, and a power supply 160. The processor 135 preferably includes a processor capable of executing program instructions and capable of communicating with the foregoing components of the control module 130. The control module 130 preferably includes code 170. Code 170 is generally defined as program instructions or software stored in a non-volatile memory such that powering off the control module 130 does not affect the storage of the code 170. The memory 140 preferably comprises non-volatile memory for storing the code 170 and the schedule downloaded from the server 110. The real time clock 145 preferably comprises a battery backed real time clock for the time dependent display of media as governed by a schedule.

The network interface 150 preferably provides for communication between the control module 130 and the server 110 and the transfer of schedules from the server 110 to the control module 130, all by way of the network 120. Moreover, updates to the code 170 in the control model 130 can also be transferred from the server 110 to the control module 130 via the network 120. According to the preferred embodiment, the network interface 150 comprises an Ethernet transceiver.

The display communicator 155 preferably provides for the display of media on the display 125. According to the preferred embodiment, the display communicator 155 comprises a VGA port. However, a skilled artisan would recognize a wide number of conventional devices, from the disclosure herein, that may comprise the display communicator 155. For example, the display communicator 155 may advantageously comprise a HDMI port, a DVI Port, a SDI port, an S-Video port, a Ethernet port, a USB port, or the like.

The power supply 160 provides sufficient power for the control module 130 to operate. Preferably, the power supply comprises conventional power outlet technology. However, a skilled artisan will recognize from the disclosure herein that the power supply 160 may advantageously include standard replaceable or rechargeable batteries, such as two ‘AA’ batteries or other conventional power supply systems.

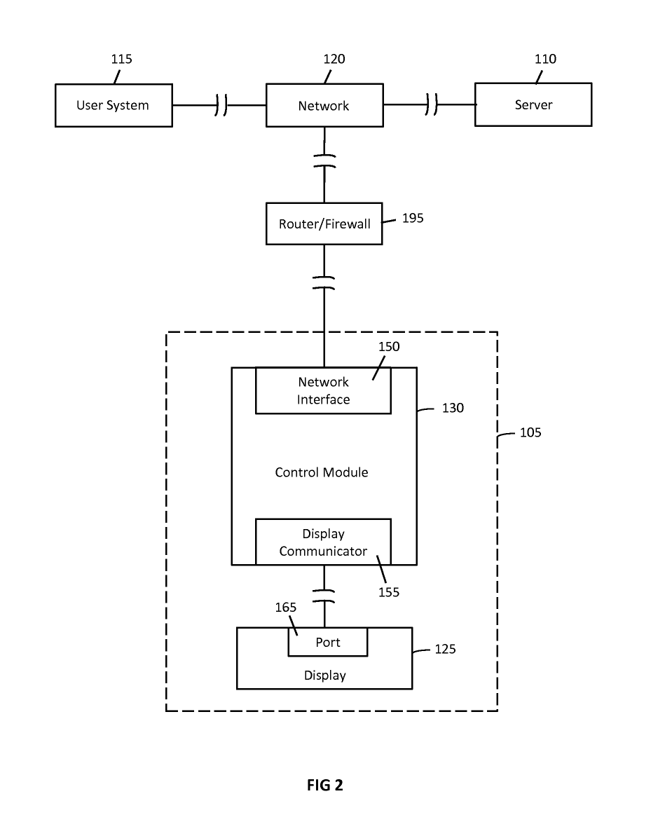

FIG. 2 illustrates a block diagram for an embodiment where the communication between control module 130 and server 110, by way of network 120, is controlled by router/firewall 195.

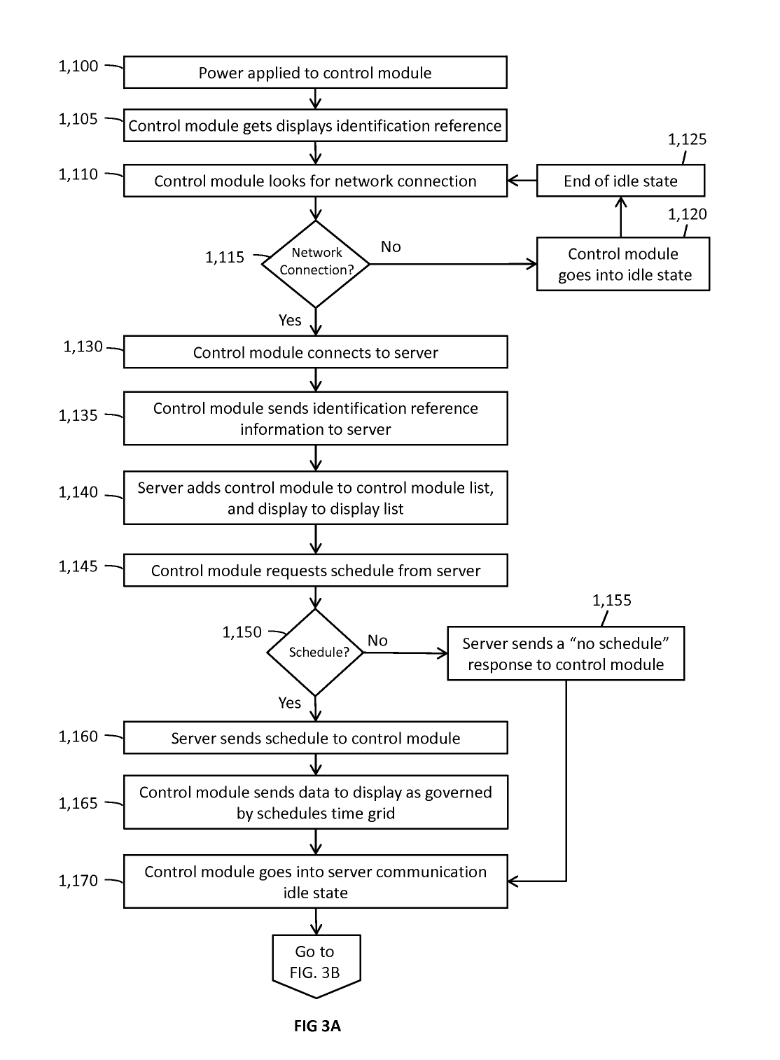

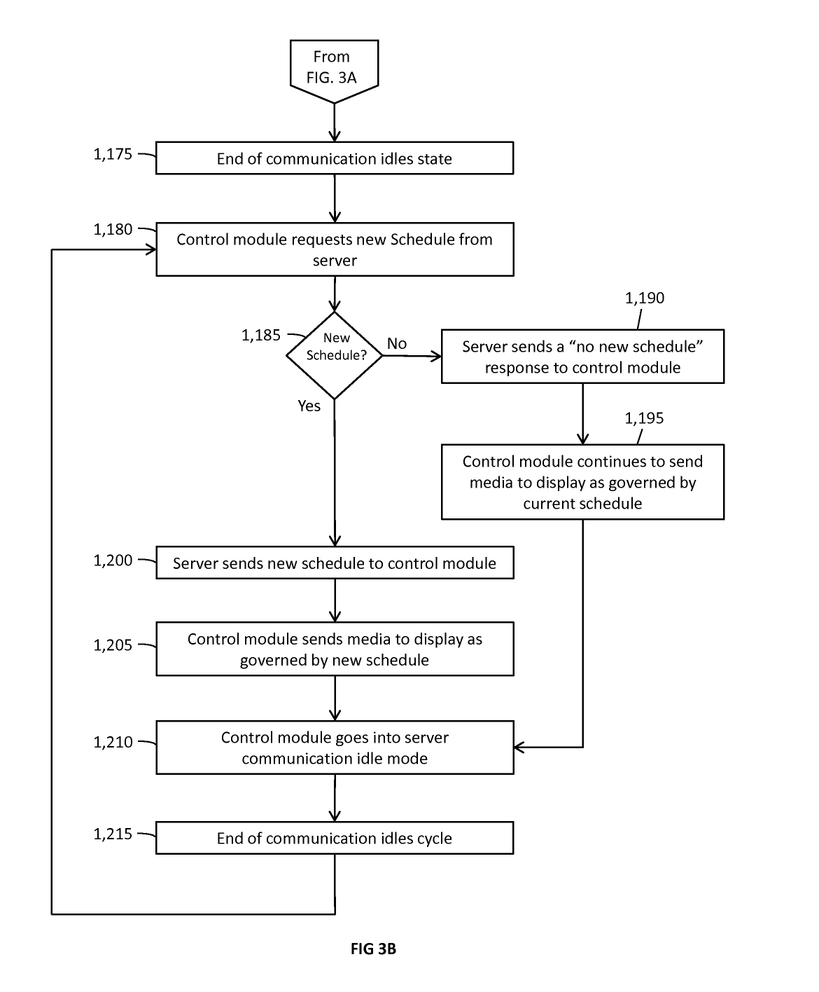

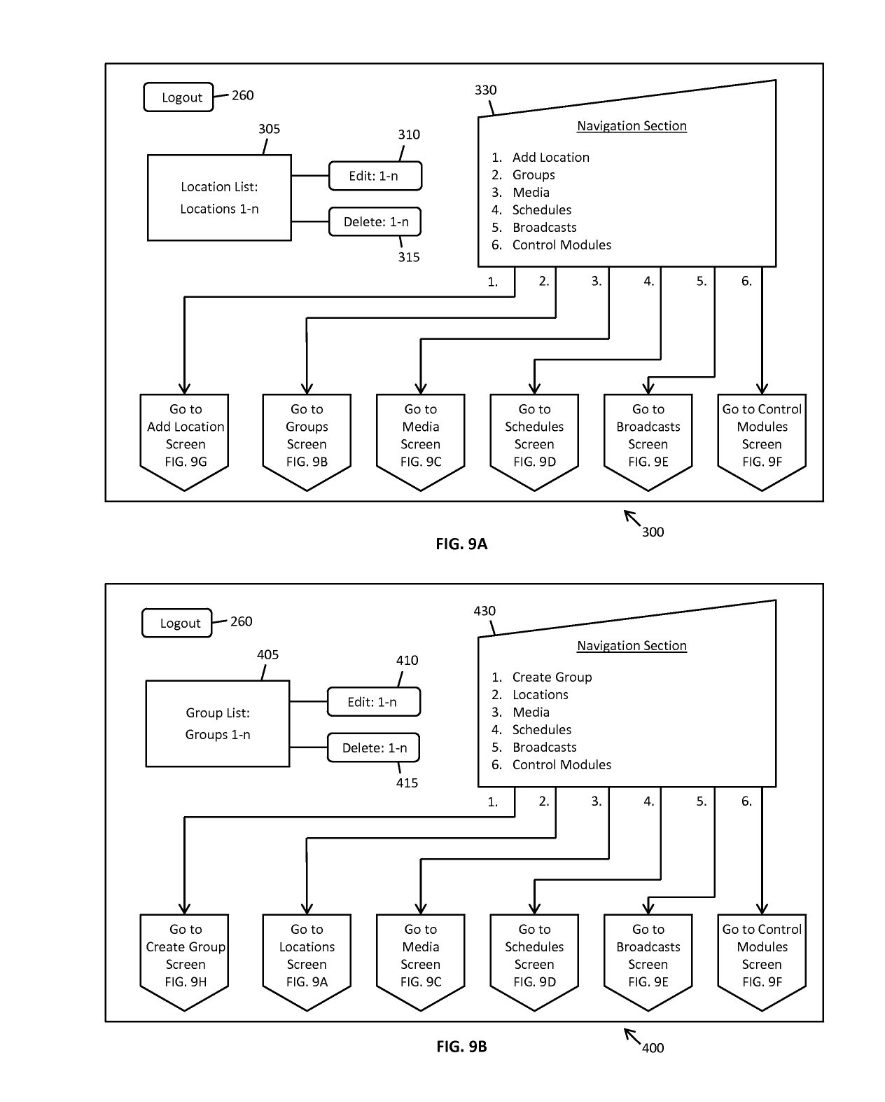

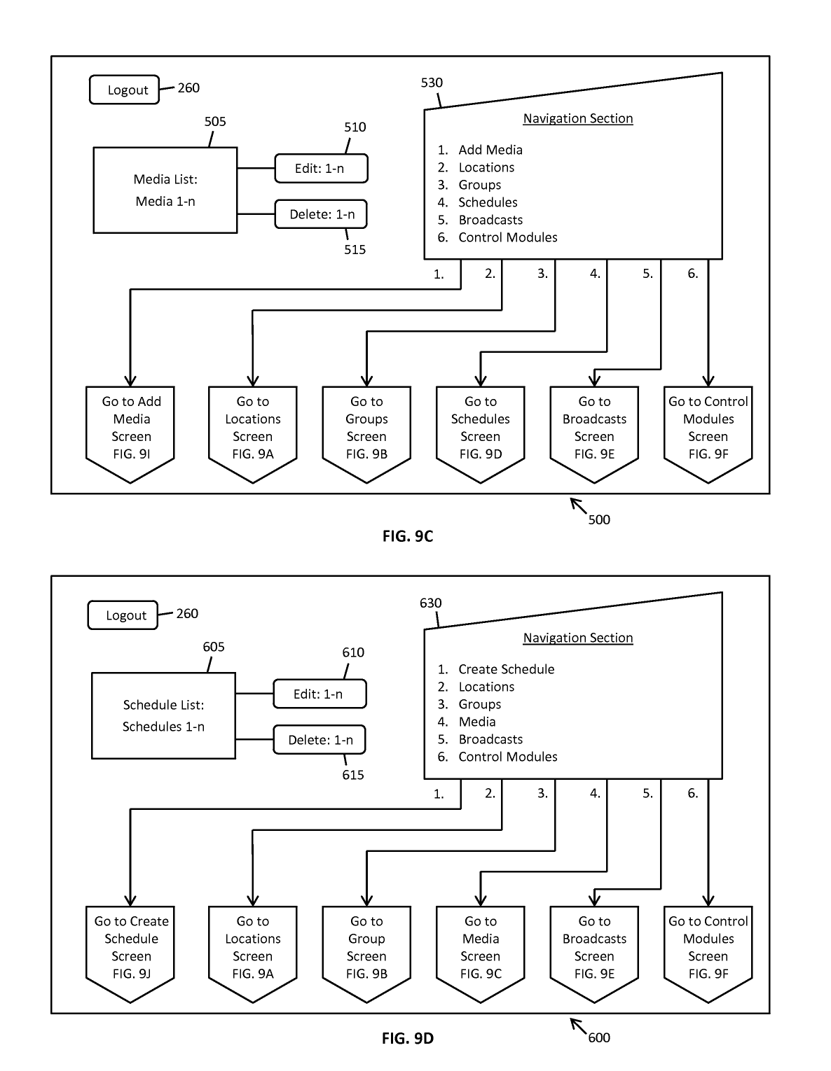

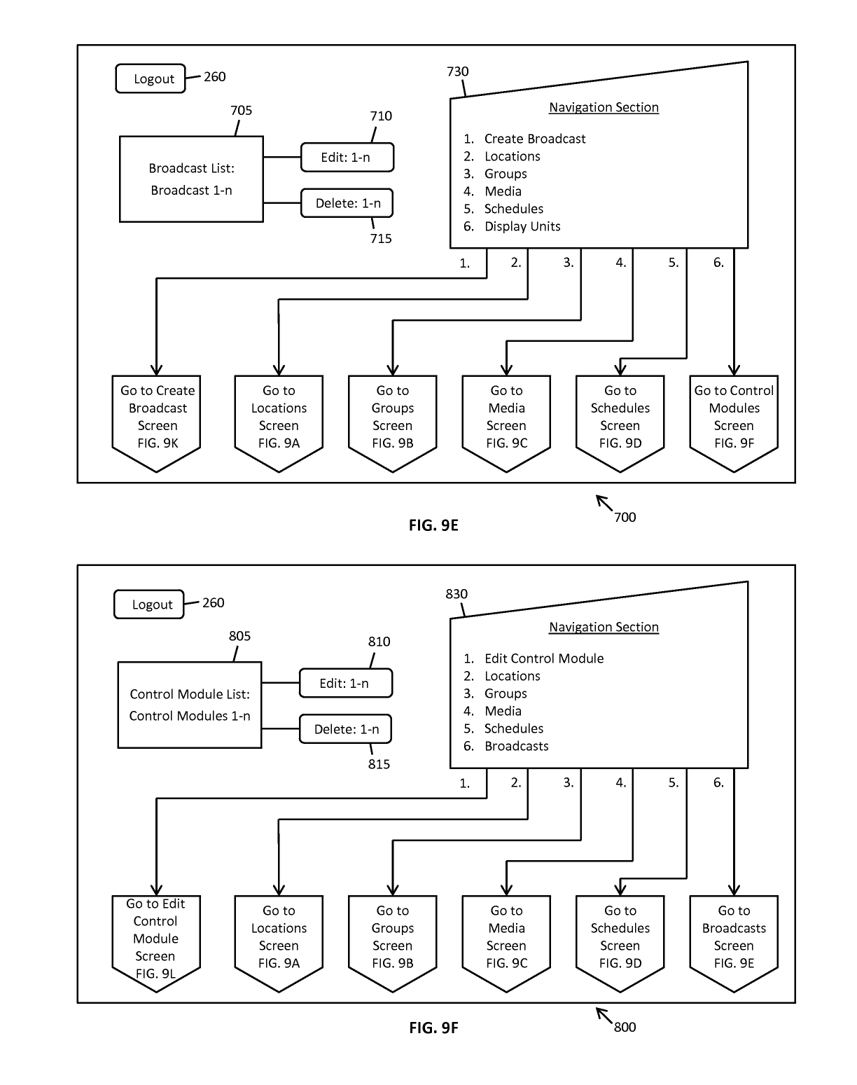

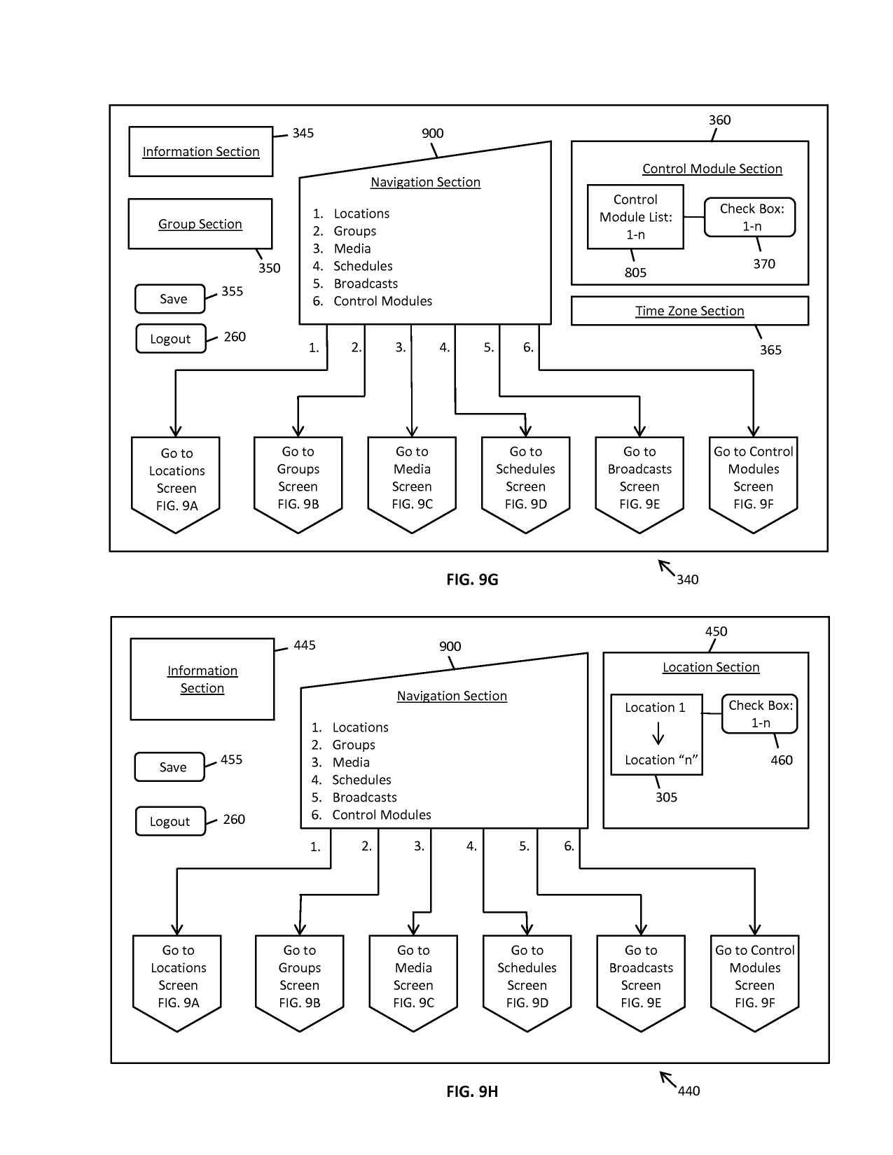

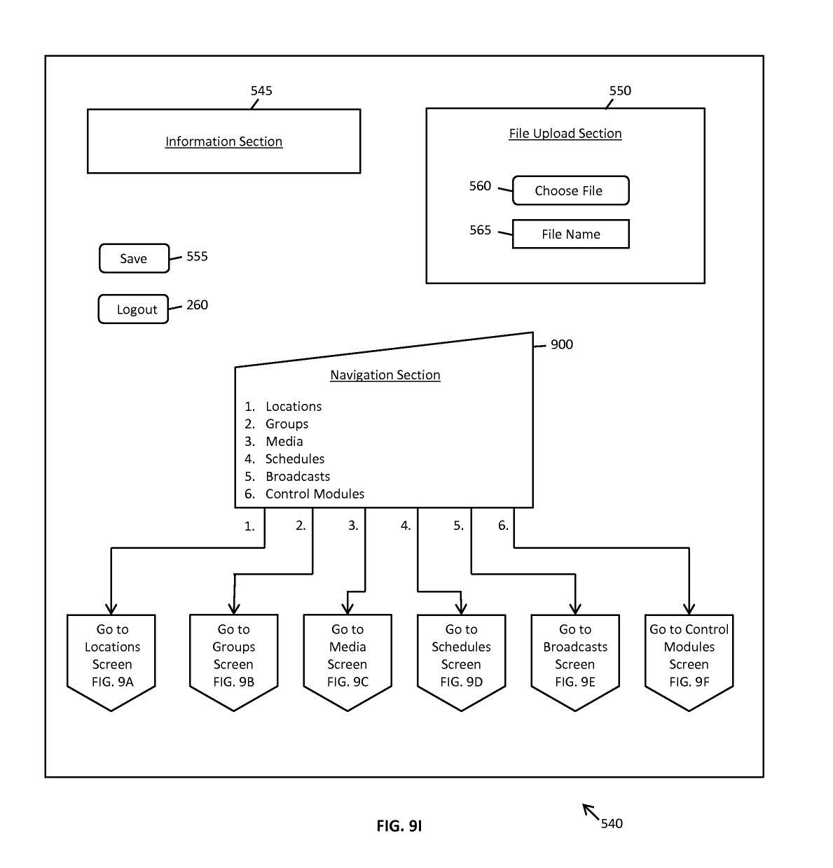

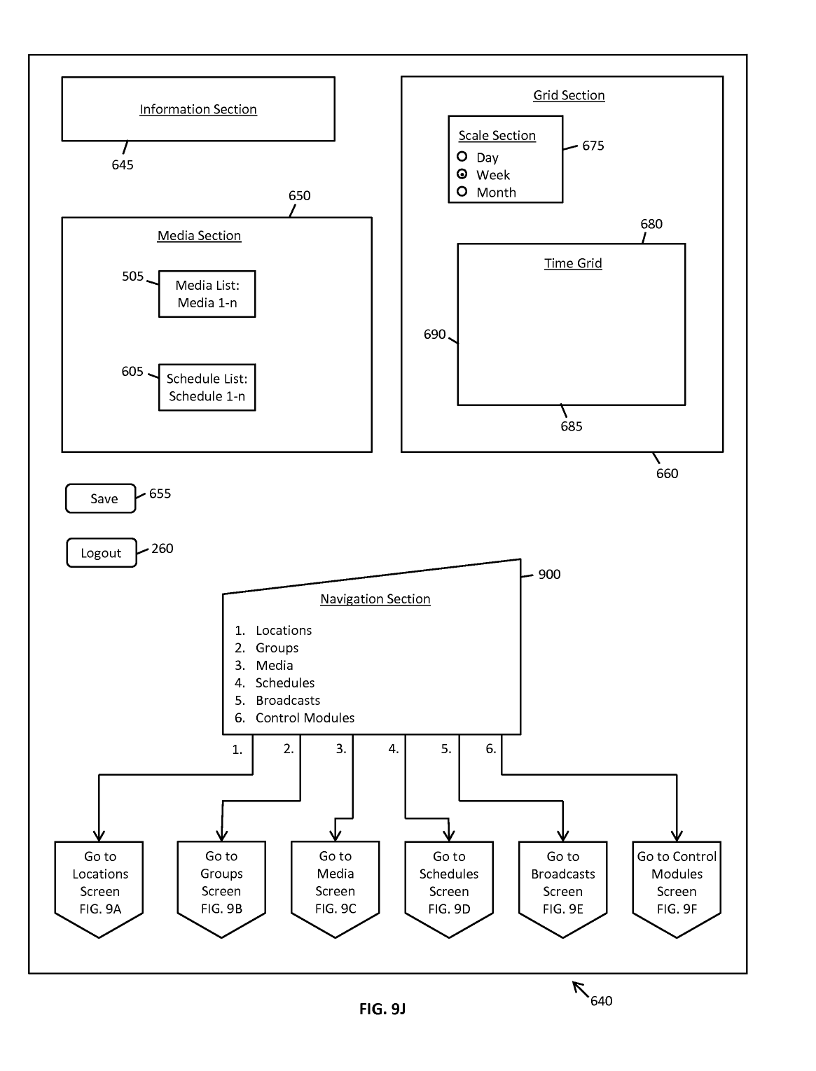

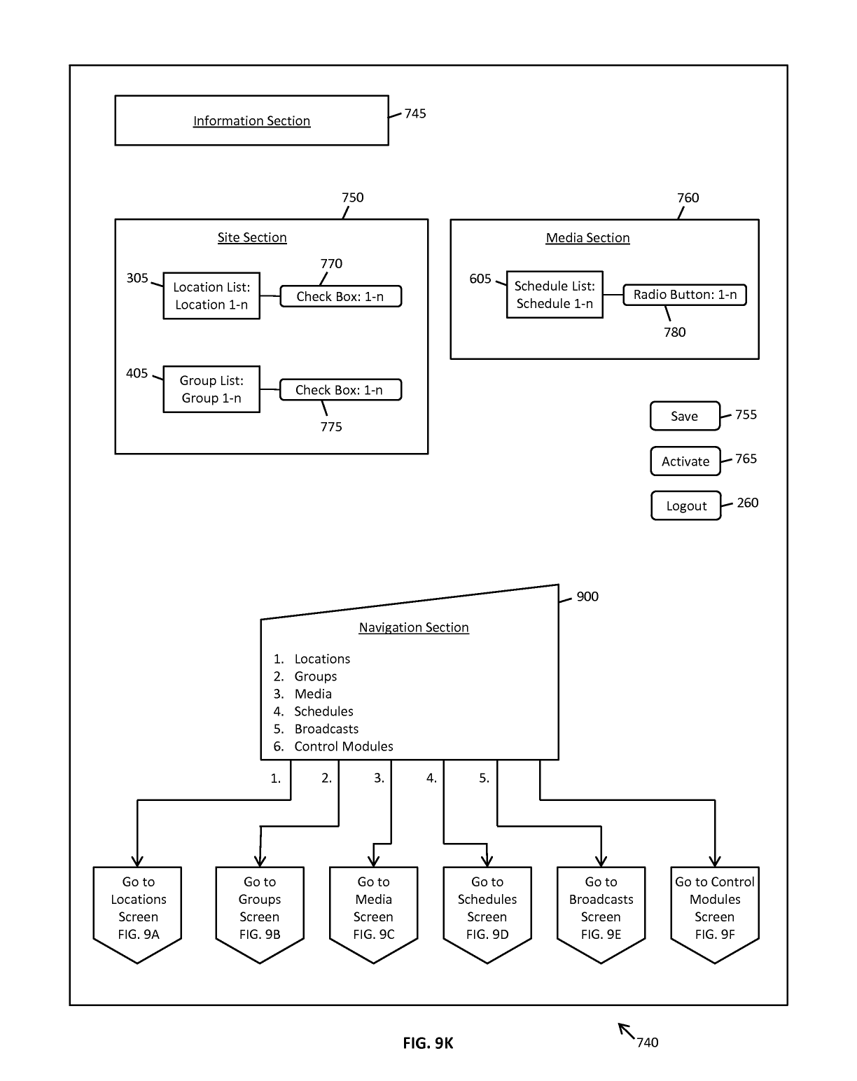

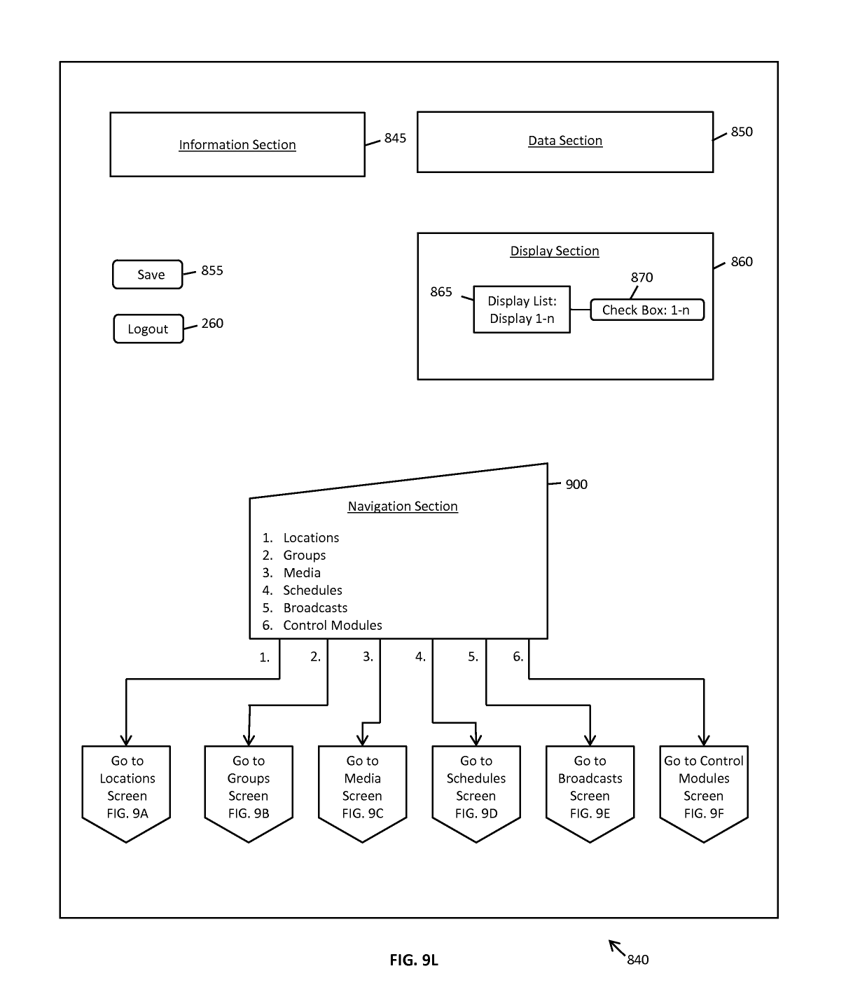

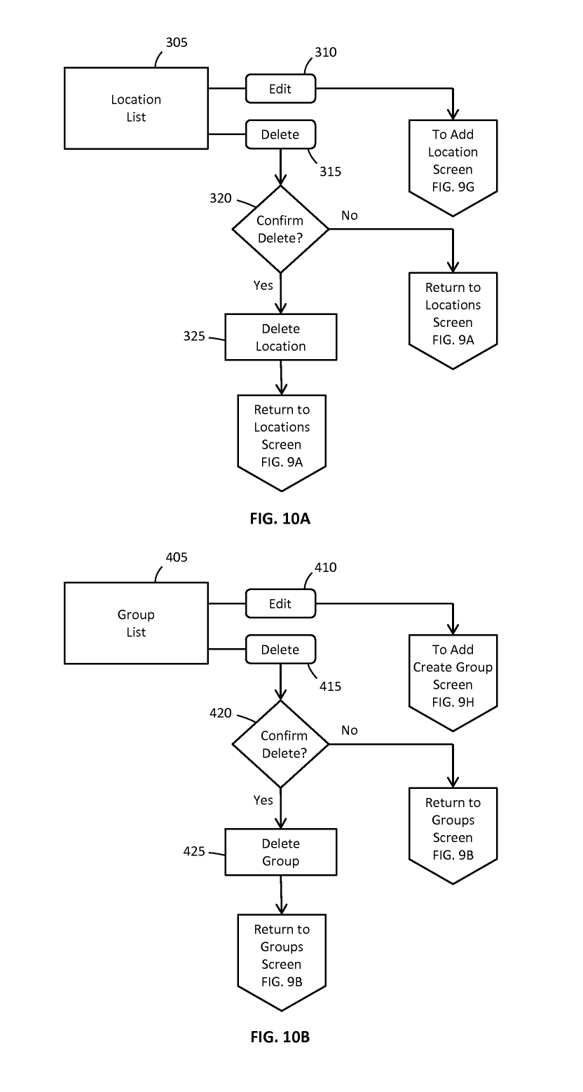

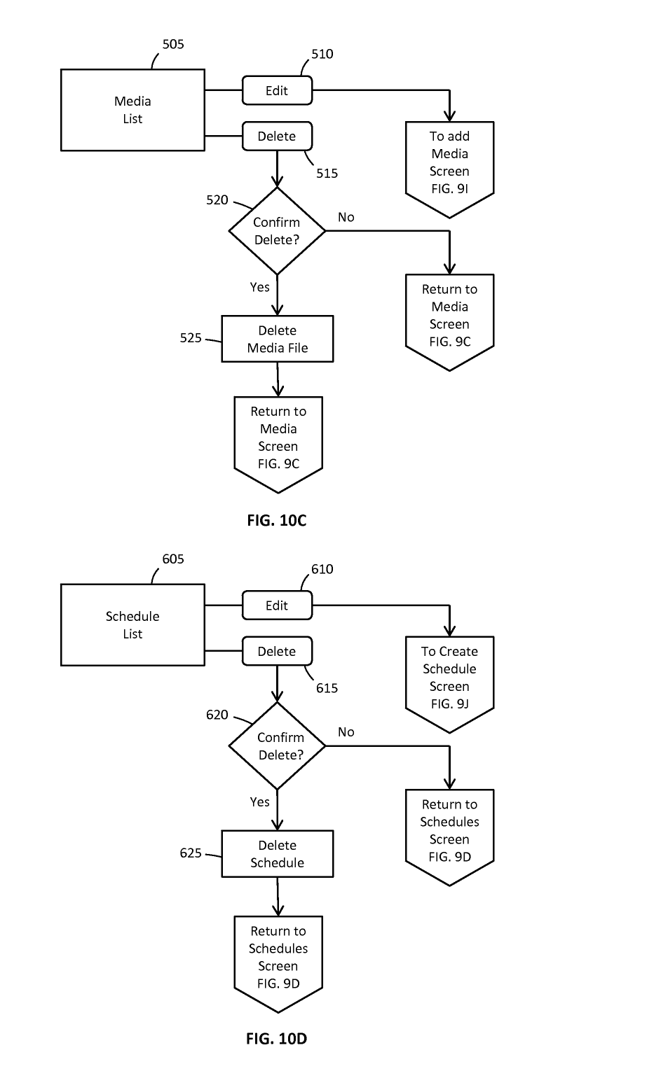

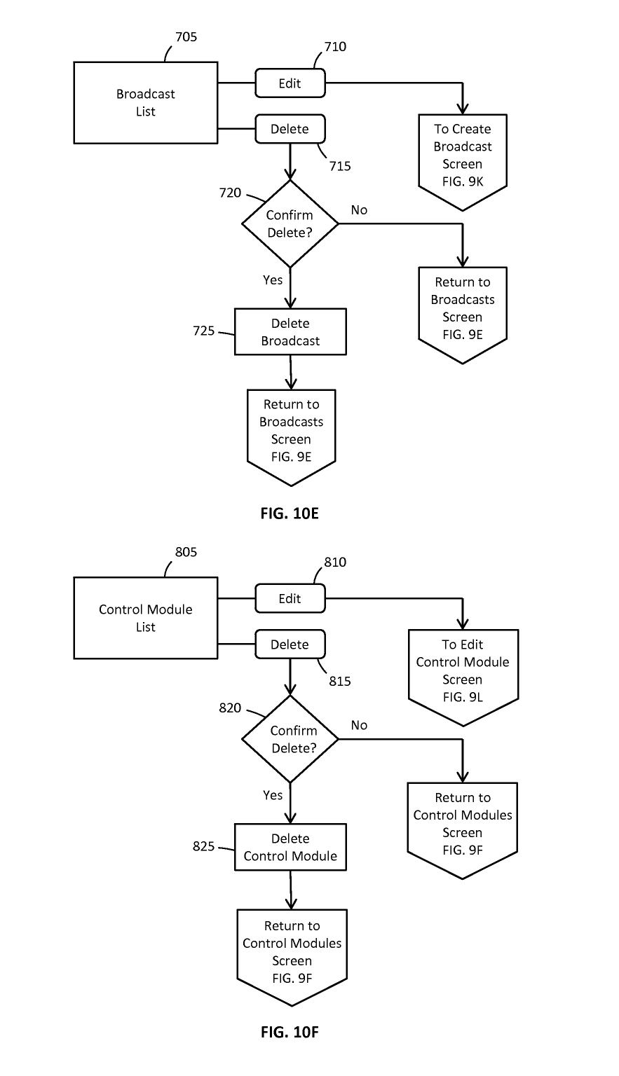

FIGS. 3A-3B illustrates exemplary flow diagrams for the method of communication between control module 130, and server 110 by way of network 120. Referring to FIG. 3A, when power is applied to control module 130, at 1,100, control module 130 retrieves the unique identification reference for display 125, at 1,105. Control module 130 looks for a connection to network 120, at 1,110. If no connection to network 120 is found, control module 130 goes into an idle state, at 1,120. When the idle state is over, at 1,125, as determined by code 170, control module 130 again looks for a connection to network 120, at 1,110. The steps 1,110 through 1,125 are repeated at the end of each idle state, at 1,125, as many times as necessary until control module 130 identifies that it has a connection to network 120, at 1,115. When control module 130 establishes a connection to network 120, at 1,115, it preferably initiates communication with server 110, at 1,130. The control module 130 sends its unique identification reference and the unique identification reference for display 125 to server 110, at 1,135, by which the control module 130 and display 125 can be uniquely identified. The server 110 adds control module 130 and its unique identification reference to control module list 805 (FIG. 9F) and adds the display 125 and its unique reference to display list 865 (FIG. 9L), at 1,140. The control module 130 requests a schedule from server 110, at 1,145. The server code 185 (FIG. 1B) queries broadcast list 705 (FIG. 9E) to determine if a schedule has been assigned to control module 130, at 1,150.

Referring still to FIG. 3A, if the user has not assigned a schedule to control module 130, server 110 sends a no schedule response to control module 130, at 1,155, and control module 130 goes into a server communication idle state, at 1,170. If the user has assigned a schedule to control module 130, the server 110 sends the schedule to control module 130, at 1,160. When control module 130 receives a schedule from server 110, control module 130 causes the media within the schedule to be displayed on display 125 as governed by the schedules time grid, at 1,165. The control module 130 goes into a server communication idle state, at 1,170, but continues to cause media to be displayed on display 125 as governed by the schedule.

Referring now to FIG. 3B, when the server communication idle state is over, as determined by code 170, at 1,175, control module 130 once again communicates with the server 110 to request a new schedule, at 1,180. The server code 185 (FIG. 1B) queries broadcast list 705 (FIG. 9E) to determine if a new schedule has been assigned to control module 130, at 1,185. If the user has not assigned a new schedule to control module 130, server 110 sends a no new schedule response to control module 130, at 1,190. The control module 130 continues to cause the media within the schedule it previously received from server 110 to be displayed on display 125, at 1,195, and the control module 130 goes into a server communication idle state, at 1,210. If the user has assigned a new schedule to control module 130, server 110 sends the new schedule to control module 130, at 1,200. When control module 130 receives a new schedule from server 110, control module 130 stops displaying the media associated with the previous schedule, and causes the media within the new schedule to be displayed on display 125 as governed by the new schedule, at 1,205. The control module 130 goes into a server communication idle state, at 1,210, but continues to cause media to be displayed on display 125 as governed by the schedule. When the server communication idle state is over as determined by code 170, at 1,215, control module 130 once again communicates with server 110 to request a new schedule, at 1,180. The steps 1,180 through 1,215 are repeated at the end of each server communication idle state, at 1,215.

Although the control module 130 and code 170 are disclosed with reference to their preferred embodiment, the invention is not intended to be limited thereby. Rather, a skilled artisan will recognize from the disclosure herein a wide number of alternative embodiments for the control module 130 and code 170. Further, the method and the steps of the method described in connection with the embodiment disclosed herein may be embodied directly in hardware, in code executed by a processor, microcontroller, or the like, or in a combination of hardware and code. Moreover, the display 125 and the control module 130 may be one integrated device.

Referring again to FIG. 1B, the user system 115 preferably includes a personal computer such as those commercially available. The user system 115 also includes network interface 175. The network interface 175 is configured to communicate with the server 110 by way of network 120. According to the preferred embodiment, network interface 175 comprises an Ethernet transceiver.

Still referring to in FIG. 1B, the server 110 includes hardware 180, server code 185 running on the hardware 180, and a database 190 located on hardware 180. The server 110 preferably includes computer hardware such as those commercially available for operating within client-server architecture across a network. The server 110 may reside in any location worldwide with connectivity to the network 120, such as, for example, a data center. A skilled artesian will recognize from the disclosure herein that the server 110 may be one device in a single location, multiple interconnected devices in a single location, or any number of devices in any number of locations interconnected by way of network 120, that comprise the server 110. Moreover, the server 110 may comprise cloud computing. Cloud computing is generally defined as the on-demand delivery of IT resources via the Internet. Amazon Web Services, for example, is one such provider of cloud computing that could be utilized for the server 110.

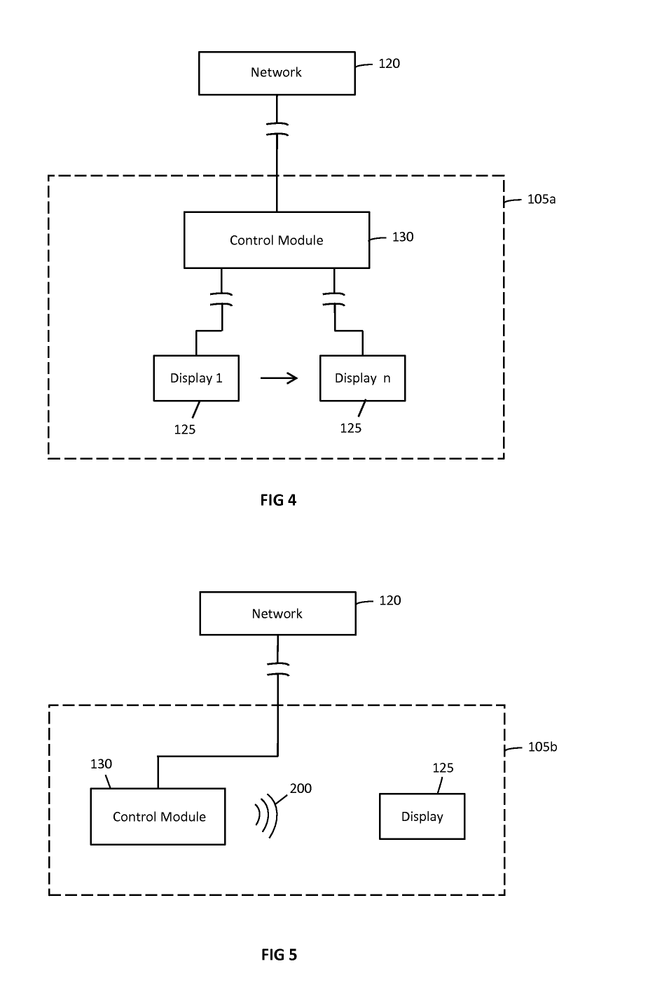

FIG. 4 illustrates a block diagram of aspects of an alternate embodiment of display unit 105. As shown in FIG. 4, in this embodiment display unit 105a is comprised of control module 130 and two or more displays 125. In this embodiment control module 130 sends the unique identification reference for each display 125 to the server 110. Further, control module 130 simultaneously causes media to be displayed on each display 125, as governed by the then current schedule and display list 865 (FIG. 9L).

FIG. 5 illustrates a block diagram of aspects of yet another embodiment of display unit 105. As shown in FIG. 5, in this embodiment display unit 105b is comprised of control module 130, which advantageously transfers media to one or more displays 125 by radio waves 200. Preferably, radio waves 200 comprise Wi-Fi radio waves. However, a skilled artisan will recognize from the disclosure herein a wide number of alternative embodiments for the radio waves 200 such as WiDi, Bluetooth, ZigBee, or the like.

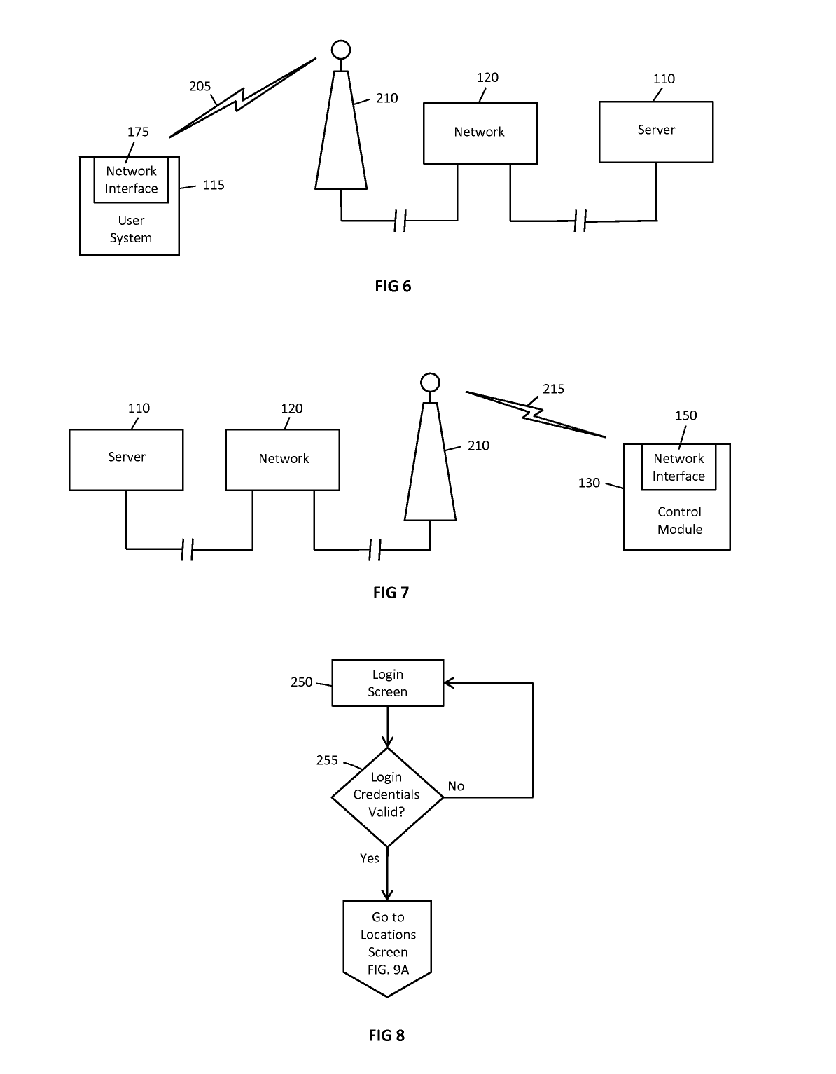

According to aspects of another embodiment of the invention illustrated in the block diagram in FIG. 6, the network interface 175 of user system 115 is configured to communicate wirelessly via radio waves 205 with cellular tower 210, which in turn communicates via network 120 with the server 110. Preferably, in this embodiment network interface 175 comprises a cellular network transceiver.

FIG. 7 illustrates a block diagram for aspects of yet another embodiment of the invention wherein the network interface 150 of control module 130 is configured to communicate wirelessly via radio waves 215 with cellular tower 210, which in turn communicates via network 120 with the server 110. Preferably, in this embodiment network interface 150 is a cellular network transceiver.

FIG. 8 illustrates an exemplary flowchart of the secure login process for server 110. The user enters their security credentials at login screen 250. The validity of the user entered login credentials are verified, at 255. If the user did not enter valid security credentials they are returned to login screen 250 and they are prompted to reenter their security credentials. If the user entered valid security credentials they are taken to locations screen 300, illustrated in FIG. 9A.

FIGS. 9A-9L illustrate exemplary user screens for the server code 185 running on the server hardware 180 and FIGS. 10A-10F illustrate exemplary flowcharts for aspects of the server code 185. The screens illustrated in FIGS. 9A-9L include conventional graphic user interface elements such as check boxes, radio buttons, text boxes, list boxes, menus, and the like.

FIG. 9A illustrates an exemplary locations screen 300. The locations screen 300 preferably includes a location list 305, a navigation section 330, and a logout button 260. The location list 305 is a list of all locations that have been created by the user using the add location screen 340 (FIG. 9G). Each location in the location list 305 has an associated edit button 310 and delete button 315.

Turning now to FIG. 10A, when the user chooses a locations edit button 310, the add location screen 340 (FIG. 9G) associated with that location is displayed, wherein previously user entered information associated with that location is displayed. When the user chooses a locations delete button 315 they must confirm that they want to delete the location, at 320. If the user confirms that they want to delete the location, the location is deleted from location list 305, at 325, and the user is returned to the locations screen 300. If, at 320, the user indicates that they do not want to delete the location, the location is not deleted from location list 305 and the user is returned to the locations screen 300.

Referring again to FIG. 9A, the navigation section 330 provides options for navigating to other screens. If the user chooses the “Add Location” option, the add location screen 340 (FIG. 9G) is displayed. If the user chooses the “Groups” option, the groups screen 400 (FIG. 9B) is displayed. If the user chooses the “Media” option, the media screen 500 (FIG. 9C) is displayed. If the user chooses the “Schedules” option, the schedules screen 600 (FIG. 9D) is displayed. If the user chooses the “Broadcasts” option, the broadcasts screen 700 (FIG. 9E) is displayed. If the user chooses the “Control Modules” option, the control modules screen 800 (FIG. 9F) is displayed. The user selects the logout button 260 to terminate their secure login session and return to the login screen 250.

FIG. 9B illustrates an exemplary groups screen 400. The groups screen 400 preferably includes a group list 405, a navigation section 430, and a logout button 260. The group list 405 is a list of all groups that have been created by the user using the create group screen 440 (FIG. 9H). Each group in the group list 405 has an associated edit button 410 and delete button 415.

Turning now to FIG. 10B, when the user chooses a group's edit button 410, the create group screen 440 (FIG. 9H) associated with that group is displayed, wherein the previously user entered information associated with that group is displayed. When the user chooses a group's delete button 415 they must confirm that they want to delete the group, at 420. If the user confirms that they want to delete the group, the group is deleted from group list 405, at 425, and the user is returned to the groups screen 400. If, at 420, the user indicates that they do not want to delete the group, the group is not deleted from group list 405 and the user is returned to the groups screen 400.

Referring again to FIG. 9B, the navigation section 430 provides options for navigating to other screens. If the user chooses the “Create Group” option, the create group screen 440 (FIG. 9H) is displayed. If the user chooses the “Locations” option, the locations screen 300 (FIG. 9A) is displayed. If the user chooses the “Media” option, the media screen 500 (FIG. 9C) is displayed. If the user chooses the “Schedules” option, the schedules screen 600 (FIG. 9D) is displayed. If the user chooses the “Broadcasts” option, the broadcasts screen 700 (FIG. 9E) is displayed. If the user chooses the “Control Modules” option, the control modules screen 800 (FIG. 9F) is displayed. The user selects the logout button 260 to terminate their secure login session and return to the login screen 250.

FIG. 9C illustrates an exemplary media screen 500. The media screen 500 preferably includes a media list 505, a navigation section 530, and a logout button 260. The media list 505 is a list of all media files that have been uploaded to the server 110 by the user using the add media screen 540 (FIG. 9I). Each media file in the media list 505 has an associated edit button 510 and delete button 515.

Turning now to FIG. 10C, when the user chooses a media files edit button 510, the add media screen 540 (FIG. 9I) associated with that media file is displayed, wherein the previously user entered information associated with that media file is displayed. When the user chooses a media files delete button 515 they must confirm that they want to delete the media file, at 520. If the user confirms that they want to delete the media file, the media file is deleted from media list 505, at 525, and the user is returned to the media screen 500. If, at 520, the user indicates that they do not want to delete the media file, the media file is not deleted from media list 505 and the user is returned to the media screen 500.

Referring again to FIG. 9C, the navigation section 530 provides options for navigating to other screens. If the user chooses the “Add Media” option, the add media screen 540 (FIG. 9I) is displayed. If the user chooses the “Locations” option, the locations screen 300 (FIG. 9A) is displayed. If the user chooses the “Groups” option, the groups screen 400 (FIG. 9B) is displayed. If the user chooses the “Schedules” option, the schedules screen 600 (FIG. 9D) is displayed. If the user chooses the “Broadcasts” option, the broadcasts screen 700 (FIG. 9E) is displayed. If the user chooses the “Control Modules” option, the control modules screen 800 (FIG. 9F) is displayed. The user selects the logout button 260 to terminate their secure login session and return to the login screen 250.

FIG. 9D illustrates an exemplary schedules screen 600. The schedules screen 600 preferably includes a schedule list 605, a navigation section 630, and a logout button 260. The schedule list 605 is a list of all schedules that have been created by the user using the create schedule screen 640 (FIG. 9J). Each schedule in the schedule list 605 has an associated edit button 610 and delete button 615.

Turning to FIG. 10D, when the user chooses a schedule's edit button 610, the create schedule screen 640 (FIG. 9J) associated with that schedule is displayed, wherein the previously user entered information associated with that schedule is displayed. When the user chooses a schedule's delete button 615 they must confirm that they want to delete the schedule, at 620. If the user confirms that they want to delete the schedule, the schedule is deleted from schedule list 605, at 625, and the user is returned to the schedules screen 600. If, at 620, the user indicates that they do not want to delete the schedule, the schedule is not deleted from schedule list 605 and the user is returned to the schedules screen 600.

Referring again to FIG. 9D, the navigation section 630 provides options for navigating to other screens. If the user chooses the “Create Schedule” option, the create schedule screen 640 (FIG. 9J) is displayed. If the user chooses the “Locations” option, the locations screen 300 (FIG. 9A) is displayed. If the user chooses the “Groups” option, the groups screen 400 (FIG. 9B) is displayed. If the user chooses the “Media” option, the media screen 500 (FIG. 9C) is displayed. If the user chooses the “Broadcasts” option, the broadcasts screen 700 (FIG. 9E) is displayed. If the user chooses the “Control Modules” option, the control modules screen 800 (FIG. 9F) is displayed. The user selects the logout button 260 to terminate their secure login session and return to the login screen 250.

FIG. 9E illustrates an exemplary broadcasts screen 700. The broadcasts screen 700 preferably includes a broadcast list 705, a navigation section 730, and a logout button 260. The broadcast list 705 is a list of all broadcast that have been created by the user using the create broadcast screen 740 (FIG. 9K). Those broadcasts whose activate check box 765 (FIG. 9K) have been checked on the create broadcast screen 740 (FIG. 9K) have a visual indicator that the broadcast is activated. Each broadcast in the broadcast list 705 has an associated edit button 710, and delete button 715.

Turning now to FIG. 10E, when the user chooses a broadcast's edit button 710, the create broadcast screen 740 (FIG. 9K) associated with that broadcast is displayed, wherein the previously user entered information associated with that broadcast is displayed. When the user chooses a broadcast's delete button 715 they must confirm that they want to delete the broadcast, at 720. If the user confirms that they want to delete the broadcast, the broadcast is deleted from broadcast list 705, at 725, and the user is returned to the broadcasts screen 700. If, at 720, the user indicates that they do not want to delete the broadcast, the broadcast is not deleted from broadcast list 705 and the user is returned to the broadcasts screen 700.

Referring again to FIG. 9E, the navigation section 730 provides options for navigating to other screens. If the user chooses the “Create Broadcast” option, the create broadcast screen 740 (FIG. 9K) is displayed. If the user chooses the “Locations” option, the locations screen 300 (FIG. 9A) is displayed. If the user chooses the “Groups” option, the groups screen 400 (FIG. 9B) is displayed. If the user chooses the “Media” option, the media screen 500 (FIG. 9C) is displayed. If the user chooses the “Schedules” option, the schedules screen 600 (FIG. 9D) is displayed. If the user chooses the “Control Modules” option, the control modules screen 800 (FIG. 9F) is displayed. The user selects the logout button 260 to terminate their secure login session and return to the login screen 250.

FIG. 9F illustrates an exemplary control modules screen 800. The control modules screen 800 preferably includes a control module list 805, a navigation section 830, and a logout button 260. The control module list 805 is a list of all control modules 130 associated with the user by way of a unique identifications reference, transmitted to the server 110 by the code 170 within each control module 130 that is in communication with the server 110. Each control module 130 in the control module list 805 has an associated edit button 810 and delete button 815. According to the preferred embodiment, each control module 130 in the control module list 805 that has been linked to a location using the add location screen 340 (FIG. 9G) has the name of that location listed next to each such control module 130. If a location is deleted from location list 305 using the locations screen 300 (FIG. 9A) any control module(s) 130 previously linked to the deleted location is no longer linked to that location, and can be linked to a different location.

Turning now to FIG. 10F, when the user chooses a control module's edit button 810, the edit control module screen 840 (FIG. 9L) associated with that control module 130 is displayed, wherein the previously user entered information, if any, associated with that control module 130 is displayed. When the user chooses a control module's delete button 815 they must confirm that they want to delete the control module 130, at 820. If the user confirms that they want to delete the control module 130, the control module 130 is deleted from control module list 805, at 825, and the user is returned to the control modules screen 800. If, at 820, the user indicates that they do not want to delete the control module 130, the control module 130 is not deleted from control module list 805 and the user is returned to the control modules screen 800.

Referring again to FIG. 9F, the navigation section 830 provides options for navigating to other screens. If the user chooses the “Edit Control Module” option, the edit control module screen 840 (FIG. 9L) is displayed. If the user chooses the “Locations” option, the locations screen 300 (FIG. 9A) is displayed. If the user chooses the “Groups” option, the groups screen 400 (FIG. 9B) is displayed. If the user chooses the “Media” option, the media screen 500 (FIG. 9C) is displayed. If the user chooses the “Schedules” option, the schedules screen 600 (FIG. 9D) is displayed. If the user chooses the “Broadcasts” option, the broadcasts screen 700 (FIG. 9E) is displayed. The user selects the logout button 260 to terminate their secure login session and return to the login screen 250.

FIG. 9G illustrates an exemplary add location screen 340. The add location screen 340 preferably includes an information section 345, a groups section 350, a control module section 360, a time zone section 365, a navigation section 900, a save button 355, and a logout button 260. The location information section 345 includes text boxes for entering information about the location, such as, for example, a name, a description, an identification number, or the like. The group section 350 identifies the group, if any, that the location has been added to using the create group screen 440 (FIG. 9H). The control module section 360 includes control module list 805. Each control module 130 in the control module list 805 that has not been previously linked to a location has a check box 370. Checking a check box 370 for a control module 130 links that control module 130 to the location, as defined by the add location screen 340. Each control module 130 that has been previously assigned to a location has the name of that location listed next to each such control module 130. Any number of control modules 130 can be linked to a location, but each control module 130 can only be linked to one location. The time zone section 365 includes a menu for selecting the worldwide time zone for the location. The user selects the save button 355 to save the information entered on the location screen 340, and add the location to the location list 305. The user is returned to the locations screen 300 after selecting the save button 355.

Referring now to FIGS. 9G-9L, the navigation section 900 provides options for navigating to other screens. If the user chooses the “Locations” option, the locations screen 300 is displayed. If the user chooses the “Groups” option, the groups screen 400 is displayed. If the user chooses the “Media” option, the media screen 500 is displayed. If the user chooses the “Schedules” option, the schedules screen 600 is displayed. If the user chooses the “Broadcasts” option, the broadcasts screen 700 is displayed. If the user chooses the “Control Modules” option, the control modules screen 800 is displayed. The user selects the logout button 260 to terminate their secure login session and return to the login screen 250.

FIG. 9H illustrates an exemplary create group screen 440. The create group screen 440 preferably includes an information section 445, a location section 450, a navigation section 900, a save button 455, and a logout button 260. The information section 445 includes text boxes for entering information about the group, such as, for example, a name, a description, or the like. The location section 450 includes location list 305. Each location in the location list 305 that has not been previously linked to a group has an associated check box 460. Checking a check box 460 for a location adds that location to the group, as defined by the create group screen 440. Any number of locations can be added to the group by checking their associated check box 460, but each location can only be added to one group. The user uses the save button 455 to save the information entered on the create group screen 440, and add the group to the group list 405. The user is returned to the groups screen 400 after selecting the save button 455.

FIG. 9I illustrates an exemplary add media screen 540. The add media screen 540 preferably includes an information section 545, a file upload section 550, a navigation section 900, a save button 555, and a logout button 260. The information section 545 includes text boxes for entering information about the media file, such as, for example, a name, a description, or the like. The file upload section 550 includes a choose file button 560, which when selected allow the user to upload a media file to the server 110 from any user accessible computer, server, or the like that is connected to the network 120, and a file name field 565, which displays the name of the media file that the user uploads. The user selects the save button 555 to save the uploaded media file and the information entered on the add media screen 540, and add the media file to the media list 505. The user is returned to the media screen 500 after selecting the save button 555.

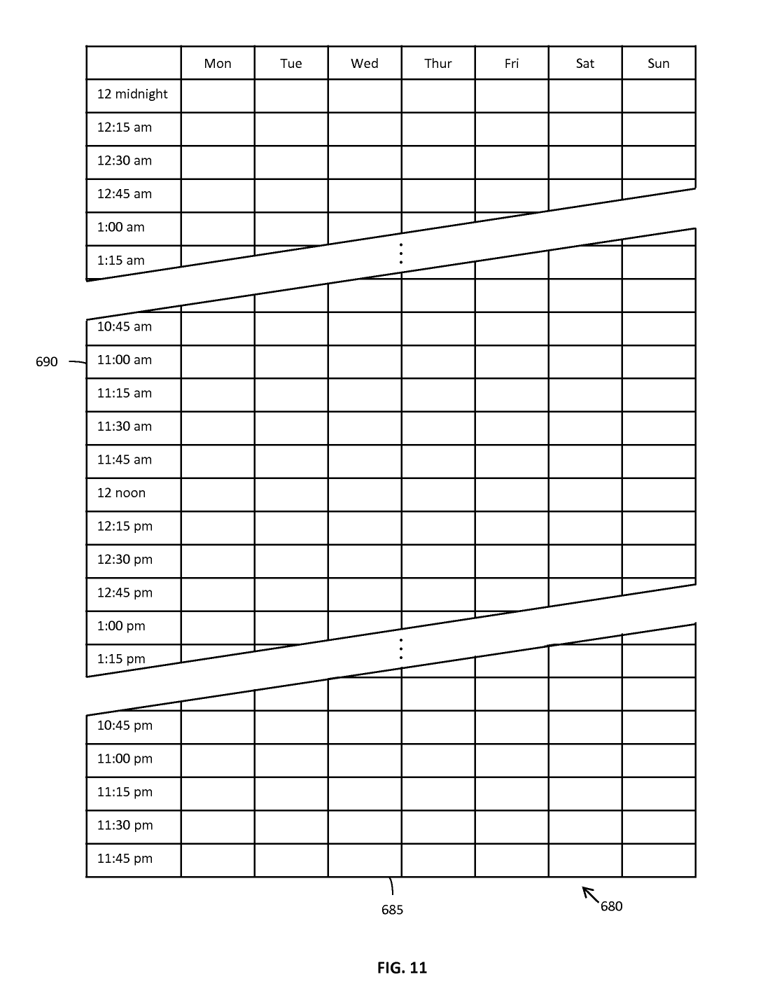

FIG. 9J illustrates an exemplary create schedule screen 640. The create schedule screen 640 preferably includes an information section 645, a media section 650, a grid section 660, a navigation section 900, a save button 655 and a logout button 260. The information section 645 includes text boxes for entering information about the schedule, such as, for example, a name, a description, an identification number, or the like. The media section 650 includes media list 505 and schedule list 605. The grid section 660 includes a scale section 675 and a time grid 680. The scale section 675 provides options for specifying the first axis 685 of the time grid 680. If the user selects the “Day” option the first axis 685 of the time grid 680 is scaled to show one day, if the user selects the “Week” option the first axis 685 of the time grid 680 is scaled to include the seven days of a week. If the user selects the “Month” option the user is prompted to select a year and the month of the year, after which the first axis 685 of the time grid 680 is scaled to represent the days of the month for the year specified by the user. The second axis 690 of the time grid 680 is scaled to represent the twenty four hours of a day. FIG. 11 illustrates an exemplary time grid 680 for which the “Week” option in scale section 675 has been selected.

Referring again to FIG. 9J, to create a schedule the user drags and drops at least one media file from the media list 505 or one schedule from the schedule list 605 in the time grid 680 on the day and at the time in the grid where they want to initiate the display of the media within the media file or schedule. After the media file or schedule is positioned in the time grid 680 the user is prompted to specify the amount of time that the media within the media file or schedule will be displayed. After doing so, no other media file or schedule can be added to the time grid 680 in that period of time. If the amount of time specified by the user for a schedule is longer than the sum of the run time for the media files within the schedule, the schedule repeats itself as necessary to fill the specified amount of time. Conversely, if the total amount of time specified by the user for a schedule is less than the sum of the run time for the media files within the schedule, the display of the media within the schedule ends at the end of the time specified by the user. The user can add any number of media files from media list 505 and/or schedules from schedule list 605 to the time grid 680 in a similar manner, up to the limitation of the time grid 680 being completely filled. No media is displayed during any period of time in the time grid 680 where no media file from the media list 505 or schedule from the schedule list 605 has been added. In one embodiment, a schedule comprises one media file occupying the entire time grid 680. In such embodiment, the media within the media file will be displayed continuously.

If the “Day” option is selected in scale section 675, the schedule will be repeated on a daily basis. If the “Week” option is selected in scale section 675, the schedule will be repeated on a weekly basis. If the “Month” option is selected in scale section 675, the schedule will be repeated after the last day of the month specified by the user. The user uses the save button 655 to save the information entered on the create schedule screen 640, and add the schedule to the schedule list 605. The user is returned to the schedules screen 600 after selecting the save button 655.

FIG. 9K illustrates an exemplary create broadcast screen 740. The create broadcast screen 740 preferably includes an information section 745, a site section 750, a media section 760, a navigation section 900, a save button 755, an activate check box 765, and a logout button 260. The information section 745 includes text boxes for entering information about the broadcast, such as, for example, a name, a description, or the like. The site section 750 includes location list 305 and group list 405. Each location in the location list 305 that has not been previously assigned to a broadcast has an associated check box 770, and each group in the group list 405 that has not been previously assigned to a broadcast has an associated check box 775. Any number of check boxes 770 and/or check boxes 775 can be selected by the user. The name of the broadcast is listed next to each location in the location list 305 and each group in the group list 405 that has been previously assigned to a broadcast. The media section 760 includes schedule list 605. Each schedule in the schedule list 605 has an associated radio box 780. Only one radio button 780 can be selected. Selecting a second radio button 780 will automatically deselect any radio button 780 that has been previously selected. Selecting one or more check boxes 770 and/or check boxes 775, and a radio button 780 defines a broadcast. When the activate check box 765 is checked, the location(s) whose check box(s) 770 and/or group(s) whose check box(s) 775 have been selected will be delivered the schedule whose radio button 780 has been selected, after the user clicks the save button 755 to save the information entered on the create broadcast screen 740, and the control module(s) 130 associated with the selected location(s) and/or group(s) request a schedule from the server 110. If the user does not check the activate check box 765 before clicking the save button 755, the broadcast is not activated and will not be delivered to any control module(s) 130 requesting a schedule from the server 110. In either case the broadcast is added to the broadcast list 705 when the user clicks the save button 755. The user is returned to the broadcasts screen 700 after selecting the save button 755.

FIG. 9L illustrates an exemplary edit control module screen 840. The edit control module screen 840 preferably includes an information section 845, a data section 850, a display section 860, a navigation section 900, a save button 855, and a logout button 260. The information section 845 includes text boxes for entering information about the control module, such as, for example, a name, a description, or the like. The data section 850 preferably includes identification data, such as, for example, the unique identification reference of the control module 130, the IP address for the location where the control module 130 is connected to the network 120, or the like. The identification reference is sent to the server 110 by the control module 130 after the control module 130 establishes communication with the server 110. The display section 860 includes display list 865, which is a list of displays 125 that the control module 130 is in communication with. Preferably, each display 125 in the display list 865 is identified by a unique identification reference sent to the server 110 by control module 130. Each display 125 in the display list 865 has an associated check box 870. Any number of check boxes 870 can be selected by the user. Only the display(s) 125 whose check box(s) 870 have been checked will be sent media by control module 130. The user uses the save button 855 to save the information entered on the edit control module screen 840. The user is returned to the control modules screen 800 after selecting the save button 855.

FIGS. 9A-9L and FIGS. 10A-10F illustrate representative features and screens of the server code 185 and a skilled artisan will recognize from the disclosure herein that more or less information, sections, navigation functions, other aspects and features, or the like, may be included.

Although the invention has been disclosed in its presently preferred and alternate embodiments, the invention is not intended to be limited thereby. Rather, a skilled artisan will recognize other combinations, omissions, substitutions, modifications and additions from the disclosure herein, including, without limitation, provision of equivalent, interchangeable or alternative embodiments which accomplishes substantially the same results as the disclosed embodiments, or constitutes an insubstantial change, that fall within the scope and spirit of the invention. Accordingly, the invention is to be defined by reference to the appended claims.

What is claimed is:

1. A method of managing and displaying media, the method comprising:
uploading at least one media file to a server;
a display unit initiating communication with the server; and
the display unit downloading the at least one media file from the server and displaying its content.

2. The method of claim 1, wherein the uploading comprises communication by way of a network, and wherein the initiating communication comprises communication by way of a network, and wherein downloading comprises communication by way of a network.

3. The method of claim 2, wherein the network comprises the Internet.

4. The method of claim 1, wherein the at least one media file comprises one of a text file, an audio file, an image file, or a video file.

5. The method of claim 1, wherein the display unit comprises a control module and at least one display, wherein the control module initiates communication with the server, downloads the at least one media file from the server and transmits the content of the at least one media file to the at least one display.

6. The method of claim 5, wherein the transmits the content is wireless transmission.

7. The method of claim 6, wherein the wireless transmission comprises radio waves.

8. The method of claim 1 further comprising:
establishing a schedule that governs when the at least one media file will be displayed on the display unit; and
the display unit downloading the schedule from the server, and wherein the displaying its content is governed by the schedule.

9. The method of claim 1, wherein communication with the server comprises cellular network communication.

10. The method of claim 1 further comprising:
a plurality of display units initiating communication with the server;
selecting at least one of the display units;
establishing a schedule that governs when the at least one media file will be displayed on the at least one display unit;
creating a broadcast comprising the schedule and the at least one display unit;
activating the broadcast; and
wherein the at least one display unit downloads the schedule from the server.

11. The method of claim 10, wherein the display unit comprises a control module and at least one display, wherein the control module initiates communication with the server, downloads the schedule and transmits the content of the at least one media file to the at least one display in accordance with the schedule.

12. The method of claim 10, wherein after the at least one display unit downloads the schedule from the server it goes into a server communication idle state, and wherein at the end of the server communication idle state the at least one display unit again initiates communication with the server and downloads a new schedule.

13. A method of managing and displaying media, the method comprising:
uploading at least one media file to a server;
at least one control module initiating communication with the server;
selecting at least one media file;
establishing a schedule that govern when the selected at least one media file will be displayed on at least one display;
creating a broadcast comprising the schedule and the at least one control module, and wherein the at least one control module downloads the schedule from the server and displays the selected at least one media file on the at least one display in accordance with the schedule.

14. The method of claim 13, wherein after the control module downloads the schedule it goes into a server communication idle state, and wherein at the end of the server communication idle state the control module again initiates communication with the server and downloads a new schedule.

15. The method of claim 13, wherein communication with the server comprises cellular network communication.

16. A display unit for displaying media downloaded from a server, the display unit comprising:
a memory configured to store media downloaded from the server; and
a processor programmed to connect to the server, download the media from the server and display the media.

17. The display unit of claim 16, wherein the processor is further programmed to display media as governed by a schedule.

18. The display unit of claim 16, wherein the processor is further programmed to periodically connect to the server, download media and display said media.

19. The display unit of claim 16, wherein the display unit comprises a control module and at least one display.

20. The display unit of claim 16, wherein connect to the server comprises cellular network connection.
